(19) United States
(12) Patent Application Publication
(10) Pub. No.: US 2008/0222604 A1
(43) Pub. Date: Sep. 11, 2008

(54) METHODS AND APPARATUS FOR LIFE-CYCLE MANAGEMENT

(75) Inventor: Kevin J. Murphy, Marlborough, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: NETWORK ENGINES, INC., Canton, MA (US)

(21) Appl. No.: 12/028,363

(22) Filed: Feb. 8, 2008

Related U.S. Application Data
(63) Continuation-in-part of application No. 11/481,089, filed on Jul. 5, 2006.
Application No. 11/481,089 is a continuation-in-part of application No. 11/368,359, filed on Mar. 3, 2006.
(60) Provisional application No. 60/889,247, filed on Feb. 9, 2007.
(60) Provisional application No. 60/659,351, filed on Mar. 7, 2005.

(51) Int. Cl. G06F 9/44

(52) U.S. Cl. 717/120

(57) ABSTRACT

The invention provides in some aspects a digital data processor executing management software that controls overall operation of the device, including, installation, configuration, updating, and/or other modifications of its software, hardware and configuration files and other “assets.” The management software validates changes to those assets (e.g., software updates and configuration file edits) requested by system administrators and others and can propagate related changes to other assets. As a result, it keeps the digital data processor in a consistent, working state, avoiding operational interruption that might otherwise result from corruption of assets (e.g., lost files) and/or attempts to install inconsistent assets. The management software can serve as an agent for one or more external digital data processing devices that are in communications coupling with the managed digital data processing device, which one or more external digital data processing devices mediate installation, configuration, updating, modification and/or use of the one or more assets.

This application claims the benefit of filing of U.S. Patent Application Ser. No. 60/889,247, filed Feb. 9, 2007. This application is a continuation-in-part of U.S. patent application Ser. No. 11/481,089, entitled “Methods and Apparatus for Digital Data Processor Instantiation,” filed Jul. 5, 2006, which is a continuation in part of U.S. patent application Ser. No. 11/368,359, entitled “Methods and Apparatus for Installation/Reinstallation of Executable Disk Images On Digital Data Processors,” filed Mar. 3, 2006, which claims the benefit of U.S. Provisional Patent Application Ser. No. 60/659,351, entitled “Methods and Apparatus for Installation/Reinstallation of Executable Disk Images On Digital Data Processors,” filed Mar. 7, 2005. The teachings of all of the foregoing applications are incorporated herein by reference.

### BACKGROUND OF THE INVENTION

The invention pertains to digital data processing and, more particularly, to methods and apparatus for managing digital data processing equipment. The invention has application, by way of example, in the lifetime maintenance of personal computers (PCs), servers, and other digital appliances.

Computers have come to dominate the corporate infrastructure. Used, first, in individual departments, labs and other pockets of the organization, they became a fixture on nearly every corporate desktop by the 1990s. Now, they have such a foothold that many businesses have more computers then employees.

The rise of the computer has been accompanied by maturation of the computer industry and commoditization of computer hardware. Enterprises looking to refine information technology investment now increasingly think of buying generic “boxes,” rather then brand-specific powerhouses of years past.

Although software has yet to undergo similar commoditization, it has faced a sea change of its own in the corporation. The demand for increasingly sophisticated and processor-hungry business applications that characterized the late 1980s and 1990s has abated. Since the recession of the early 2000s and with the emergence of open source software, today's corporate IT department is now as likely to pick and choose among offerings of diverse makers as it is to buy the software suite of a single one.

Part and parcel with these changes, IT departments more routinely keep old computers, putting them to work on less resource-intensive tasks, rather than relinquishing them to lease companies or selling them for scrap. While this demands more of the IT staff in monitoring and maintenance, it can reduce costs and increase overall stability.

An object of this invention is to provide improved methods, apparatus and systems for digital data processing.

A more particular object of the invention is to provide such methods, apparatus and systems as facilitate the management of digital data processing equipment and/or software.

A related object of the invention is to provide such methods, apparatus and systems as facilitate maintaining personal computers (PCs), servers, and other digital appliances over their lifetimes.

A further object of the invention is to provide such methods, apparatus and systems as can be implemented at reasonable cost on existing and future platforms.

### SUMMARY OF THE INVENTION

The foregoing are among the objects attained by the invention, which provides in some aspects a digital data processor executing management software that controls overall operation of the device, including, installation, configuration, updating, and/or other modifications of its software, hardware and configuration files and other “assets.” The management software validates changes to those assets (e.g., software updates and configuration file edits) requested by system administrators and others and can propagate related changes to other assets. As a result, it keeps the digital data processor in a consistent, working state, avoiding operational interruption that might otherwise result from corruption of assets (e.g., lost files) and/or attempts to install inconsistent assets.

In related aspects of the invention, the management software of a digital data processor of the type described above monitors changes made (or attempted) by an external device, a system administrator, a field technician, or otherwise to insure that those changes are permissible and, if not blocks them. The software can, according to related aspects of the invention, validate the state of the digital data processor before or in connection with making such a change, e.g., by inventorying its assets and insuring that (a) they match an expected inventory based, for example, on a prior inventory or cataloging of assets, and/or (b) they represent a “consistent” inventory of assets (e.g., an inventory of software and hardware that are compatible and/or can be expected to work well together). The management software can also make a back-up of the digital data processor's software, configuration files and other soft assets prior to effecting a requested change.

In further related aspects of the invention, the management software of a digital data processor of the type described above quashes a change if validation fails, e.g., because the inventory did not match expectations (for example, due to a missing or mismatched driver, an incorrect or configuration file, an absent hardware device). The reason for such failure can also be logged and reported, e.g., so that the management software, an external device, a system administrator, a field technician or other can effect a roll-back of the digital data processor to a prior consistent, working state.

Other aspects of the invention provide a digital data processor as described above in which the management software “unlocks” the digital data processor in order to permit a requested change to go forward. This can include, by way of non-limiting example, making available for access by the change processes hidden, protected and/or encrypted files, operating system functions and/or registry entries. Likewise, after implementing or attempting to implement any requested (and related) changes, the management software can “lock” the digital data processor, e.g., by hiding, protecting and/or encrypting such files, operating system function and/or registry entries, thereby, preventing or minimizing the risk of subsequent unauthorized or unmanaged modifications, e.g., by users, system administrators, field technicians, unauthorized processes.

Still further aspects of the invention provide a digital data processor as described above in which the management software—in addition to changing assets requested, e.g., by the external device, a system administrator, a field technician, or other to insure—propagates related changes to other assets, e.g., by modifying them for accord and/or consistency with the requested changes. This can include, by way of example, installing updated drivers for hardware assets implicated by the originally requested change. disabling conflicting software or hardware assets, updating configuration files, and so forth. According to related aspects of the invention, information for driving these additional modifications can be pre-programmed into the management software, obtained from external devices or other sources, or otherwise.

Yet still further aspects of the invention provide a digital data processor as described above in which the management software takes in inventory of the digital data processor's assets following successful updating, e.g., in order to provide for validation in connection with future change requests and/or providing a checkpoint for roll-backs.

Further aspects of the invention provide a managed digital data processing device as described above in which the management software serves as an agent for one or more external digital data processing devices that are in communications coupling with the managed digital data processing device (e.g., over a network). Through that agent, those external digital data processing devices mediate installation, configuration, updating, modification and/or use of assets on the managed digital data processing device.

Related aspects of the invention provide a managed digital data processing device as described above in which the management software limits and/or confirms installation, configuration, updating and/or use of at least selected assets absent authorization by one or more of the external devices. In this regard, the management software can have exclusive right for such operations vis-a-vis at least selected assets on the respective device.

Still further related aspects of the invention provide a digital data processing device as described above in which the management software detects a selected condition in any of state, configuration and operation of a respective aspect of the managed device. That software can generate an error message and/or other notification in response to detection of such a condition, e.g., for transmission to the external devices. To this end, the management software can comprise one or more daemons, each executing in the kernel of the operating system of the managed device, modeling a respective aspect of that device and detecting a selected condition therein.

Related aspects of the invention provide a managed digital data processing device as described above in which one or more of the daemons generates an error message and/or other notification in response to detection of such a selected condition. Further related aspects of the invention provide a such device in which one or more of the daemons perform such modeling with state machines.

According to related aspects of the invention, the daemons can include one or more of an asset management daemon to any of start, stop and remove an asset of the managed digital data processing device, a phone home daemon to any of pull and push information to one or more selected external devices, a provisioning daemon to configure one or more assets, an image management daemon to manage a software image of the managed digital data processing device, a health management daemon to generate notifications in response to detection of selected conditions on the managed digital data processing device, a licensing daemon to validate assets that are installed and/or used on the managed digital data processing device, an event daemon to effect one or more actions based on one or more events any of within or outside the managed digital data processing device, a change management daemon to monitor and/or control installation, configuration, updating and/or use of at least selected assets on the managed digital data processing device, a database daemon to manage infrastructure in support of the management software, and a randomized instruction set emulation daemon to secure the managed digital data processing device from attack.

Other aspects of the invention provide systems and methods for digital appliance life-cycle management in which a hierarchy of digital data processing devices cooperate in managing one or more digital data processing devices, e.g., of the type described above, by controlling the installation, configuration, updating and/or use of at least selected assets on those managed devices, where those assets can include any of software, hardware and configuration files.

Thus, one aspect of the invention provides such a digital data processing system comprising a first set of one or more digital data processing devices and a second set of such devices that are coupled to the first set. One or more devices in the second set mediate installation, configuration, updating, modification and/or use of assets (e.g., applications, hardware and/or configuration files) on at least a selected digital data processing device in the first set by (a) monitoring the operation of that device, and (b) responding to one or more selected conditions in that monitored device by selectively installing, configuring, updating and/or limiting unauthorized modification of assets on that selected device.

Related aspects of the invention provide a digital data processing system as described above in which at least the selected digital data processing device comprises management software, as described above, that serves as an agent for the one or more devices in the second set. That management software can, for example, restrict installation, configuration, updating and/or use of at least selected assets (and/or configuration files) on the selected digital data processing device absent authorization by one or more devices in the second set.

Further aspects of the invention provide hierarchical systems for digital appliance life-cycle management as described above comprising a third set of digital data processing devices that are coupled in between and to the first and second sets in order to mediate the transfer of information from at least a selected digital data processing device of the first set to one or more devices of the second set.

According to one such aspect of the invention, one or more devices in the third set monitor the operation of one or more devices in the first set and respond to selected conditions in at least the selected digital data processing device of that set by notifying one or more devices in the second set of such conditions. A device in the second set can respond to such notification by selectively installing, configuring, updating, modifying and/or permitting use of assets on the selected digital data processing device, e.g., via the management software on that device.

By way of non-limiting example, a life-cycle management server (e.g., in the “second set”) operated by an appliance life-cycle maintenance bureau can cooperate with home office servers (“third set”) operated by a customer to manage digital data processing equipment (“first set) at the customer's local offices. The home office servers monitor operation of local equipment, directly attending to customer-specific operational issues, such as customer-specific application and/or data transfer errors. The home office servers pass other issues to the maintenance bureau's server, e.g., those pertaining to hardware, operating system, or other managed software or asset errors, so that it (the bureau's server) can mediate installation, configuration, etc., of assets of the local equipment.

Further related aspects of the invention provide a system as described above in which at least a selected digital data processing device of the third set includes a database of the aforesaid error messages, notifications or other selected conditions detected in operation of at least the selected digital data processing device of the first set. One or more records or fields (or other aspects) of that database may be marked, for example, as reportable or otherwise accessible to one or more digital data processing devices of the second set.

Yet other aspects of the invention provide systems as described above in which one or more devices of the second and/or third sets monitor at least the selected digital data processing device of the first set—and, likewise, the digital data processing devices of the second set monitor those of the third set—to detect a selected condition in any of state, configuration and operation of such a monitored device.

Related aspects of the invention provide a system as described above in which (i) at least the selected digital data processing device of the first set generates error messages and/or other notifications, (ii) one or more selected digital data processing devices of the second and/or third sets respond to such messages and/or other notifications to identify the aforesaid selected conditions in the operation of the selected digital data processing device and to any of install, configure, update, modify and/or permit use of assets thereon in response thereto.

According to related aspects of the invention, such a managed digital data processing device can include a security module that limits (or prevents) operation, modification and/or connectivity of the computer, e.g., absent physical, electrical, electromagnetic, magnetic, or other coupling of a token (such as a key fob, smart card, credit card, or the like) and/or external authorization, e.g., from a vendor or third-party, via the Internet (or external network). The firewall device, too, can include such a security module, for example, that limits its operation, modification and/or connectivity, again, for example, absent a token and/or external authorization.

Other aspects of the invention provide a managed digital data processing device as described above in which the computer is prevented from installation, configuration, updating, modification and/or use of at least selected assets (e.g., hardware and/or software) in the absence of a token and/or external authorization. Likewise, the firewall device can be prevented from configuration, modification and/or use of assets—and, thus, for example, from permitting the computer to access the Internet (or other external network) and/or selected addresses thereon.

Still further aspects of the invention provide methods of digital data processor life-cycle management paralleling the operations of the digital data processing devices and methods described above.

These and other aspects of the invention are evident in the drawings and in the text that follows.

### BRIEF DESCRIPTION OF THE DRAWINGS

A more complete understanding of the invention may be attained by reference to the drawings, in which:

FIG. 1 depicts a managed digital data processing device according to one practice of the invention;

FIG. 2 depicts a method according to the invention of updating an asset in the digital data processing device of FIG. 1;

FIG. 3 depicts a managed digital data processing device according to another practice of the invention; and

FIG. 4 depicts a digital data processing system for appliance life-cycle management according to one practice of the invention.

### DETAILED DESCRIPTION OF THE ILLUSTRATED EMBODIMENT

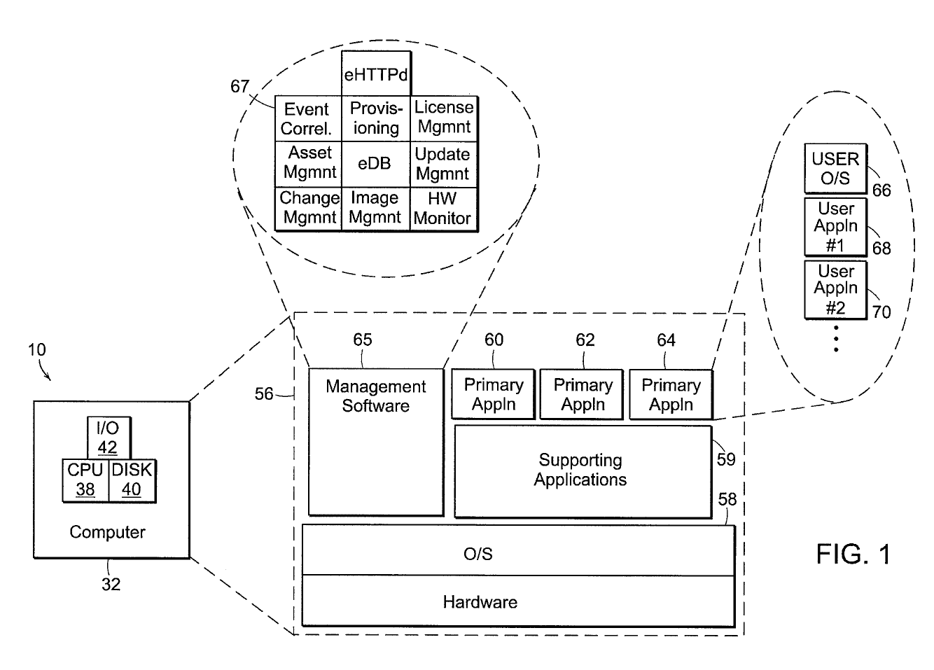

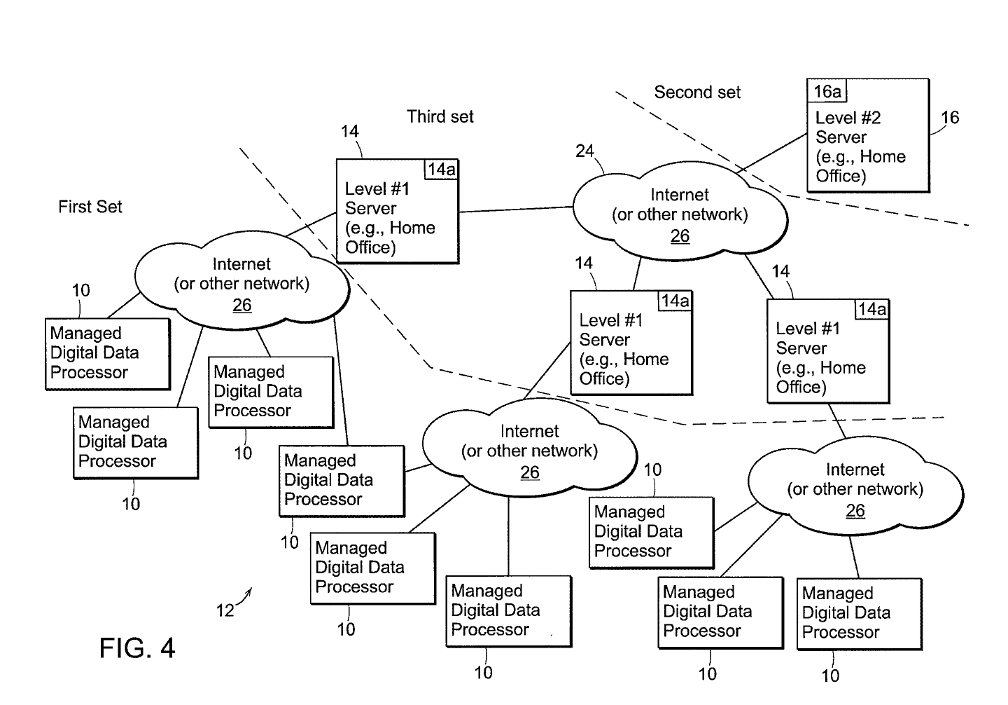

FIG. 1 depicts an exemplary managed digital data processing device 10 according to one practice of the invention. With reference to the drawing, the device 10 comprises computer 32 having a CPU 38 and static storage, e.g., by way of non-limiting example, a disk drive 40, static RAM, or the like. It also includes input/output (I/O) section 42 providing peripheral access. In this regard, I/O section 42 includes a network interface card, modem or other interface suitable for communication to the Internet or other network (e.g., network 26 of FIG. 4). In the illustrated embodiment, that interconnect supports communications via Ethernet protocol, though other embodiments may support communications via other protocols, industry-standard, proprietary or otherwise.

Device 10 may comprise an embedded processor, personal digital assistant (PDA), personal computer, mainframe, or other digital data processing apparatus of the type known in the art capable of executing applications, programs, and/or processes—all as adapted for operation in accord with the teachings hereof. Once so adapted, device 10 and computer 32 may be employed as a “general purpose computer,” a special purpose computer (e.g., a router, a network security appliance, a communications appliance), personal digital assistant, MP3 player, game player, or other digital data processing device, depending on user needs and on applications and other assets incorporated therein.

FIG. 1 depicts software installed on computer 32. Specifically, disk 40 (and other stores) includes executable disk image 56 comprising operating system code 58, applications software 59-64, as well as as attendant configuration, initialization, data and other files (collectively, “configuration files”) used in the course of operation of computer 32. Additionally, the disk image 56 includes management software 65. Together with the hardware that makes up computer 32 (and device 10), the image 56, the operating system 58, the software 59-65, and the aforementioned configuration files comprise the “assets” of that device 10. In other embodiments of the invention, those assets may be deemed to constitute only a subset of the foregoing, e.g., the primary software applications 60-64 and configuration files.

Applications 60-64 (“primary applications”) represent applications installed on computer 32 (and executing on operating system 58), typically, at the request of and/or for the benefit of the user. These are often the raison d'être for device 10 from the user's perspective. By way of non-limiting example, in a device 10 and/or computer 32 configured as a network security appliance, these applications 60-64 may be network security (and related) applications; in a device 10 or computer 32 configured as a telecommunications appliance, these may be telecommunications (and related) applications; and so forth. In some embodiments of the invention and, in particular regard for example to embodiments wherein management software 65 serves as an agent for external devices (e.g., 14, 16), management software 65 can be configured to permit these applications to operate (although, not necessarily to be installed, configured, updated or otherwise modified) without approval or other intervention of those external devices—unless, by way of non-limiting example, such use requires at least periodic external approval for operation (as in the case of applications whose use is “metered” for license or other purposes).

In some embodiments, one or more of the applications, e.g., application 64, comprise a virtual machine, itself, providing a contained environment (with necessary memory spaces, registries, stacks, environmental variables, and so forth) for execution of an operating system 66 and one or more applications 68, 70. Virtual machine 64 can be a Virtual PC®, VMware®, or any other virtual operating system suitable for execution on computer 32.

Applications 68, 70 represent any applications code suitable for execution on operating system 66, under virtual machine 64, and so forth.

Application 59 comprises a supporting application (such as, Microsoft Internet Security and Acceleration Server (ISA), ISA plug-ins, Microsoft Internet Information Server (IIS), Hewlett-Packard's Open View, IBM's Biztalk, Altiris, and so forth) that executes on operating system 58 and that is used to support the primary applications 62-64 and is largely transparent to (or abstracted from) the end user.

Although three primary applications 60-64 and one support application 59 are shown in the drawing it will be appreciated that a greater or lesser number of either is contemplated by the invention.

Operating system code 58 (and, likewise, operating system 66) can be, by way of non-limiting example, selected from the Windows™ family of operating systems, Linux, Unix, Mac OS X®, or any other proprietary or nonproprietary operating system suitable for execution on computer 32 (and/or, in the case of operating system 66, virtual machine 64), adapted for operation in accord with the teachings hereof.

Management software 65, also executing on operating system 58, controls overall operation of the device 10 and/or computer 32, including, installation, configuration, updating, and/or other modifications of its software, hardware and configuration files and other “assets.” As discussed below (and elsewhere herein) it validates changes to those assets (e.g., software updates and configuration file edits) requested by system administrators and others and can propagate related changes to other assets. As a result, it keeps the digital data processor in a consistent, working state, avoiding operational interrupts that might otherwise result from corruption of assets (e.g., lost files) and/or attempts to install inconsistent assets.

In this regard, software 65 of the illustrated embodiment can serve as an agent for one or more external devices (e.g., digital data processing devices 14 and/or 16, discussed below) that are in communications coupling with the respective device 10 and/or computer 32, e.g., via a network. More particularly, in the illustrated embodiment, management software 65 restricts installation, configuration, updating and/or use of at least selected assets on the respective digital data processing device 10 absent authorization from those external device(s). However, in other embodiments, software 65 may be pre-programmed or otherwise to manage assets of device 10 and/or computer 32, e.g., without reference to such external devices.

Regardless, in the illustrated embodiment, such control by management software 65 is effected by affording it “root,” “super user” and/or “administrative” privileges on computer 32 (or, more precisely, with respect to O/S 58), at least with respect to creation, updating and/or deletion of assets. Such privileges are, in some embodiments, to the exclusion of those of all other users (e.g., system administrators, field engineers, and so forth), at least with respect to creation, updating and/or deletion of such assets. This ensures that province for at least the installation, configuration, updating, and/or modification of the assets on device 10 and/or computer 32 remains with software 65 (and, in embodiments where it serves as an agent for external devices, e.g., 14, 16, with such external devices). To these ends, the management software 65 can respond to user attempts and/or detection of conditions indicating the need to perform those actions by confirming their permissibility, e.g., via the external devices or otherwise (or, for example, in the case of user attempts, by prohibiting them outright). This is likewise true of user attempts to use (e.g., execute, operate and/or access) assets.

Regardless of their type, the software 65 may identify such attempts by monitoring O/S 58 notifications re access violations (e.g., in instances where the software 65 has exclusive right to install, configure, update and/or use the assets), by monitoring file system or other service calls within the O/S 58, by providing a controlled interface for user interaction with the O/S 58 and computer 32, or otherwise

More generally, management software 65 can monitor the assets—as well, more generally, of the computer 32 and/or respective device 10—and generate error messages and/or other notifications in response to detection of a selected condition in any of state, configuration and operation thereof. Those conditions can range from erroneous operation of an asset, missing assets, unauthorized attempts to install, configure, update and/or use an asset, and so forth. To this end, the management software 65 of the illustrated embodiment comprises one or more daemons 67, each executing on the operating system 58 and modeling a respective asset and/or other aspect of respective managed digital data processing device 10 and/or computer 32. Upon detection of a selected condition in regard to its respective asset or aspect, the daemon can generate an error message or other notification, e.g., for logging and/or, in embodiments where management software 65 it serves as an agent for external devices (e.g., 14, 16) for routing to those devices 14, 16.

Though other embodiments may vary in both number and type, the illustrated embodiment utilizes the following daemons operating, e.g., in the kernel of the O/S 58:
an Asset Management daemon to intervene (start/stop/remove) on a given asset based on policies. This can be effected, for example, by policies stored locally, while leveraging Health Monitoring, Event Correlation, and Change Management daemons. The Asset Management daemon can, for example, report hardware and software inventory at manufacturing and on demand, and it can report actions taken to maintain appropriate software inventory.
a Phone Home daemon to pull (in) or push (out) data to a secure known source for reporting or instructions (e.g., external devices 14, 16). This facilitates remote support, management, and updating of systems and minimizing the need for on-site personnel. The daemon utilizes a state machine and XML-based communications for instructions. It is used in connection with updates, registration and alarms, as well as provisioning.
a Provisioning daemon to configure the respective managed digital data processing device 10 and/or computer 32 by abstracting individual assets components and without keyboard, video, monitor (KVM). This can be effected by an XML engine behind basic web based communications—e.g., XML instructions over HTTP(S)-leveraging the infrastructure of the Phone Home and other daemons.
an Image Management daemon to manage the respective device 10 (and, particularly, computer 32) as an image 56, rather than the individual components. This has the advantage that management is self-contained and occurs with minimal downtime. It also permits quick reliable recovery, secure image to hardware, fewer component dependencies to manage. It can be effected by coordinating building of image with an image management engine wrapper.
a Health Monitor daemon to generate an alarm/alert in response to passive monitoring of hardware or software assets. This has the advantage of providing proactive management to maximize uptime and predictable performance. It can be effected by building a persistence layer, integrating hardware monitoring, and developing/integrating software monitoring. It can, further, utilize multiple methods for delivering alarms/alerts. Development of the monitor can include SMTP delivery of hardware alarms/alerts, software alarms, integrating with system log functionality, and providing ability to send alarms back through the system 12 framework.
a License Management daemon to ensure that only valid software is installed and running on computer 32. This ensures integrity of the system, enables control and evaluation of components, and compliancy. It can be effected by coordination of Asset management, Change Management, Phone Home, and Health Monitor daemons. Development can include reporting all licensed components and versions locally through a user interface, and reporting expired/expiring software assets, e.g., to external devices (such as digital data processing devices 14, 16).
a an Event Correlation daemon for taking an action based on the context of one or more events on or off the digital data processing device 10 and/or computer 32. This can be effected by storing policies in a database and leveraging software monitoring. It can, moreover, integrate with the Asset Management daemon. Development can include creating alerts based on policies, intervening in connection with the Asset Management Daemon, and integrating with the R.I.S.E. daemon.
a Change Management daemon that provides multilevel ACL for creation, reading, updating and deletion of components and subcomponents (i.e., assets) on the respective managed device 10 and/or computer 32. This ensures control over the device 10 and/or computer 32 without need for external systems. It also permits tracking of attempted changes and logons for reporting or achieving service level agreements (SLAs). It can be effected by developing local user management and enabling standalone change management control at the kernel level. Development can include tracking of users relative to access level and any activity, autolocking the respective device 10, and permitting remote lock and unlock as part of Update Management.
a Database Management daemon providing infrastructure for the management software 65 and for management of the device 10 and/or computer 32. This provides a single control point with data relationships and facilitates the use of text-based data. It can be effected through a database engine, such as SQLite, via a data access layer. Development can include creation of a separate database from Health Monitoring daemon and creation of a data access layer, as well as extending database schema to related applications.
a randomized instruction set emulation (R.I.S.E.) daemon to securing the computer 52 from buffer overflow and code-injection attacks, since updates are a result of component vulnerability.

In addition, the management software 65 can include a web server daemon, such as eHTTPd, or other interface, to facilitate both end user and administrator access and configuration.

Although the managed device 10 and/or computer 32 shown in FIG. 1 (as well as in FIG. 4, discussed below) are depicted as conventional hardware devices, they may comprise virtual machines, as well. Thus, for example, one or more of the computers 32 (and, more generally, devices 10) may be made up of management software 65 and applications 59-64 that execute on an operating system 58 which, itself, executes on a hypervisor—i.e., a virtualization platform that permits multiple operating systems to simultaneously run on a digital data processing device.

In such instances, daemons 67 that make up the management software 65 in each virtual machine are hampered (by the nature of the virtualization itself) in detecting the state of the hardware platform on which they are executing and/or discerning what, if any, other virtual machines may be executing on that same platform. To overcome this, a master version of the management software executes on the hardware platform outside any such virtualization and communicates with, and oversees, the management software 65 within the respective virtual machines of that same hardware platform. A benefit of this is to insure that inappropriately matched virtual machines (e.g., virtual machines supporting software of two competitors, both of whom prohibit running their own software with that of the competitor on the same hardware) do not simultaneously run on the same hardware platform.

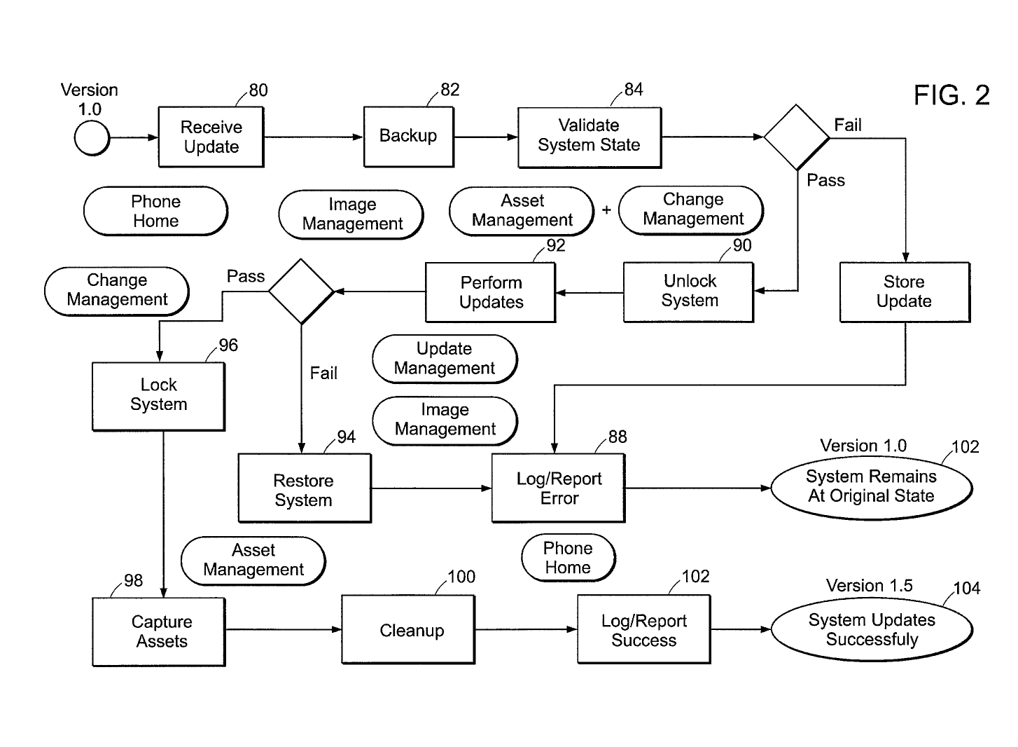

FIG. 2 is a flow diagram illustrating the steps executed by a managed device 10 according to one practice of the invention—and particularly, for example, by daemons 67 executing thereon—in responding to a software update received, e.g., from an external device (such as digital data processing device 16, discussed below), to bring an exemplary asset from Version 1.0 to Version 1.5. Steps in the update process are depicted by large rectangular elements. Decision blocks are indicated by diamonds. Daemons involved in the various steps are indicated by small, rounded rectangles. The dark circle depicts the initial state, e.g., of a software asset being updated. Ovals depict final state of that asset.

Thus, in step 80, the Phone Home daemon receives an update for one or more of the assets of the digital data processing device 10. This can be code for new or updated operating system code 58, applications software 59-64, and/or attendant configuration, initialization, data and other files—all by way of non-limiting example. It can be received from external devices 14, 16, resident in files stored on the device 10 itself, obtained by request initiated by management software 65 or otherwise.

Regardless, in step 82, the Image Management daemon backs up an image 56 of device 10 (and, particularly, computer 32) to insure that the update process will proceed (or fail) atomically—i.e., that if the update does not to proceed to successful completion (resulting in a consistent, working state of the device 10 that includes the new version of the asset being updated), it will leave device 10 in (or restore it to) its last consistent, working state that includes the original, non-updated version of that asset (as well as another other assets updated in step 90, as discussed below). Such backup, which can be a full, incremental, differential or otherwise, can be performed in the conventional manner known in the art for disk image backup.

In step 84, the Asset Management and Change Management daemons validate the state of device 10 (and, particularly, computer 32). Thus, for example, the Asset Management daemon can log hardware and software inventory prior to the update for comparison with the expected state of that inventory, which comparison can be performed by the Asset Management Daemon and/or the Change Management daemon. In addition, the Change Management daemon can track the users and/or processes that requested the update, e.g, to insure that they/it are appropriately authorized.

According to one preferred practice, the validation performed in step 84 includes inventorying assets of the digital data processor 10 and/or computer 32 to insure that (a) they match an expected inventory based, for example, on a prior inventory or cataloging of assets, and/or (b) they represents a “consistent” inventory of assets (e.g., an inventory of software and hardware that can be expected to work well together). In the former regard, the Asset Management daemon can rely on a log of assets generated in connection with a prior update or modification of the system and/or on a listing or log of assets that is pre-programmed, provided by an external device, or otherwise. In the latter regard, the Asset Management daemon can likewise rely on a listing of compatible and/or incompatible assets that is pre-programmed, provided by an external device, or otherwise.

If validation fails, the proposed updating is quashed and processing proceeds to step 86 (where the update is stored, e.g., for later processing and/or diagnostic evaluation) and step 88 (where an error is logged and/or reported). Such failure can occur, by way of non-limiting example, because of missing or inappropriate driver, an incorrect configuration file, an absent hardware device, and/or where the inventory of assets did not otherwise match expectations and/or represent a compatible collection. Following logging and/or reporting, digital data processor 10 and computer 32 can proceed in the normal course or, alternatively, management software 65, an external device, a system administrator, a field technician or other can effect a roll-back of the digital data processor 10 to a prior consistent, working state.

Otherwise, in step 90, the Change Management daemon unlocks device 10 (and, more particularly, computer 32) and otherwise readies it for updating. Such unlocking can be performed (if necessary), by way of non-limiting example, by making hidden, protected and/or encrypted files, operating system functions and/or registry entries available for access by the update processes (i.e., the daemons or other processes or functions responsible for implementing the update), e.g., so that they can proceed to successful completion in normal course.

In step 92, Update Management proceeds with execution of the updates. In the illustrated embodiment, this proceeds in the normal course—once the device 10 (and, more particularly, computer 32) has been appropriately unlocked and/or readied per step 90—by installation of the updates received in step 80.

Preferably, step 92 additionally includes propagating related changes to other assets, i.e., modifying other assets of the device 10 and/or computer 32, if and as necessary, for accord and consistency with the updates received in step 80. This can include, by way of example, installing updated drivers for hardware assets implicated by the update, disabling conflicting software or hardware assets, updating configuration files, and so forth, to name just a few examples. Tables and/or other information for driving these additional changes can be received from external devices (e.g., devices 14, 16), obtained in separate and/or additional requests generated by management software 65 to such external devices or other sources, pre-programmed in management software 65, or otherwise.

If the update step 92 does not proceed to normal successful completion, the Image Management daemon restores the backup image created in step 82, rolling back the device 10 (and, more particularly, computer 32) to its pre-update state and, thereby, insuring atomicity. See, step 94. It then logs and/or reports any error information obtained from the failed update. See, step 88.

Conversely, if the update does proceed to normal successful completion, the Change Management daemon locks the device 10 (and, more particularly, computer 32) to prevent or minimize the risk of subsequent unauthorized or unmanaged modifications, e.g., by users, system administrators, field technicians, unauthorized processes, etc. See, step 96. This is performed, by way of non-limiting example, by hiding, protecting and/or encrypted files, operating system functions and/or registry entries in a manner conventional in the art, or otherwise, so that any such unauthorized or unmanaged modifications cannot proceed to successful completion.

In step 98, the Asset Management daemon performs an asset capture in order to obtain an inventory of files and other assets that make up the updated system, e.g., for use in connection with validating the system in connection with further updates or other change requests, and/or providing a checkpoint for requested roll-backs. The asset capture can be followed with a post-update cleanup, e.g., to delete files and otherwise free resources temporarily consumed by the update process. See, step 100. This can be accomplished in the conventional manner known in the art, as adapted in accord with the teachings hereof. In step 102, the Phone Home daemon reports successful update, e.g., to a system administrator, external device 14, 16, and/or otherwise.

As indicated by ovals 104, 106, the update process shown in steps 80-102 is atomic: the final state of the asset in question is either successfully updated (here, to Version 1.5) or kept/restored to its original state (here, Version 1.0). In either event, when the process completes, the management software 65 insures (through the steps of FIG. 2, or otherwise) that the system remains in a consistent, working state.

It will be appreciated that sequence shown in steps 80-102 is just an example of an update process in a system according to the invention and that other embodiments may employ other steps, instead and/or in addition. Thus, by way of non-limiting example, it will be appreciated that not all embodiments of the invention utilize locking step 94 and, conversely, unlocking step 90 but, rather, merely rely on validation step 84 (and, conversely, asset capture step 98) to determine whether unauthorized/unmanaged changes have been made to the system state.

Although FIG. 2 and the discussion above are directed to a process following receipt of an update, e.g., from an external device, it will be appreciated that the management software 65 can operate similarly in response to update requests from a system administrator, field technician or other. In such a case, execution of the additional modifications discussed above in connection with step 90 (e.g., modifications of other assets for accord and consistency with the requested updates) can prove helpful to insuring that the device 10 and/or computer 32 remain in consistent, working state before and after the requested operation, since, the system administrator, field technician or other may lack sufficient knowledge (or otherwise fail) to make such additional modifications on his or her own.

It will also be appreciated that a similar set of steps can be effected by the management software in response to other changes to assets of the managed device 10 and/or computer 32.

For example, if an external device, system administrator, field technician or other attempts to remove a software asset or configuration file, a procedure like that shown in FIG. 2 can be executed to insure that the requested operation proceeds smoothly and predictably, if at all—and, significantly, as above, that the system remains in a consistent, working state before and after the requested operation. With particular reference to the drawing, a procedure for uninstallation/deletion of an asset can proceed as shown, albeit with step 80 replaced by a “request uninstall/deletion” step; step 86 replaced by a “store request” step; and step 92 replaced by a “perform uninstall/deletion” step.

Likewise, by way of further example, if an external device, system administrator, field technician or other attempts to install a software asset, a procedure like that shown in FIG. 2 can also be executed (again, insuring that the system remains in a consistent, working state before and after the requested operation). With particular reference to the drawing, a procedure for installation of an asset could proceed as shown, albeit with step 80 replaced by a “request install” step; step 86 replaced by a “store request” step; and step 92 replaced by a “perform installation” step.

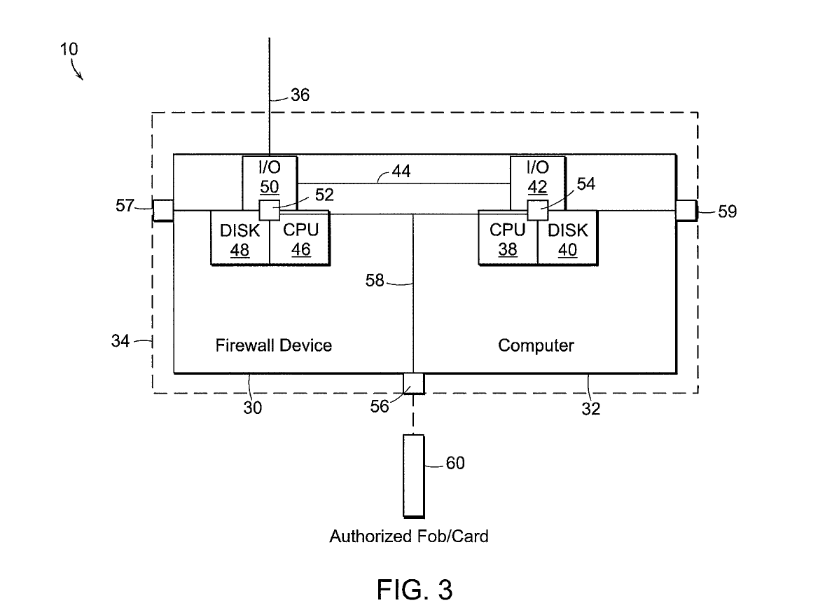

FIG. 3 depicts a further exemplary managed digital data processing device 10 according to the invention. Such a device 10 can be used instead of, or in addition to, devices of the type shown in FIG. 1, e.g., in a system 12 of the type depicted in FIG. 4. The illustrated device 10 of FIG. 3 is generally constructed and operated in the manner of device 10 of FIG. 1, however the device 10 of FIG. 3 includes a firewall device 30, in addition to computer 32 (which operates as discussed above, e.g., in connection with FIG. 1). These share a common path 36 to the Internet or other external network 26, yet, they do not share the same substantive processing logic. Moreover, the devices 30 and 32 of the illustrated embodiment are co-housed within a “common enclosure” 34. As used herein “common enclosure” refers to a chassis, housing and/or other structure (individually or in combination) suitable for containing digital data components for handling and use. By way of illustrative, non-limiting example, devices 30 and 32 can be co-housed within a 1U, 3U or other-sized rack-mount enclosure, e.g., of the type commercially available in the marketplace.

In preferred embodiments, the enclosure 34 is suitable for containing devices 30 and 32 not only for facilitating their handling and use as a unit but, also, for preventing handling and use of either of the devices without the other. Some such embodiments secure the devices 30 and 32 within the enclosure 34, for example, by way of epoxy or otherwise, so that attempts to physically access either device 30, 32 without the other results in breakage and/or is otherwise frustrated.

Still other embodiments utilize a “virtual” common enclosure. Thus, although in those embodiments, the two devices 30 and 32 are not contained in a physical common enclosure, they are coupled (physically, electronically, optically, or otherwise) such that one cannot be used (though it might be moved) without the other—and, specifically, in some embodiments such that the computer 32 cannot be used without the firewall device 30.

As above, computer 32 of the illustrated embodiment comprises a CPU 38 and static storage, e.g., by way of non-limiting example, a disk drive 40, static RAM, or the like. It also includes input/output (I/O) section 42 providing peripheral access. In this regard, I/O section 42 includes a network interface card, modem or other interface suitable for communication with firewall device 30 via interconnect 44 and, optionally, thereby, to the Internet or other external network 26. In the illustrated embodiment, that interconnect supports communications via Ethernet protocol, though other embodiments may support communications via other protocols, industry-standard, proprietary or otherwise. Computer 32 is a “general purpose computer” in the illustrated embodiment; however, other embodiments, it may be a special-purpose computer, personal digital assistant, MP3 player, game player, or other digital data processing device.

Firewall device 30 selectively blocks packets traveling between digital data device 10 and network 26, e.g., over path 36 to the Internet or other external network 26. That path 36 comprises a T1 line, T3 line, Ethernet, wireless link, satellite link, or other direct, indirect, modulated or other communications path of the type suitable supporting communications between digital data device 10 and network 26. The firewall is coupled to the path 36 via a network interface card, modem, or other communications mechanism appropriate therefor. The device 30 operates in the conventional manner of firewalls known in the art, as adapted in accord with the teachings hereof, e.g., to restrict connectivity between the computer 32 (and, more generally, device 10) and network 26 absent authentication.

In this regard, as shown in the drawing, computer 32 is coupled to network 26 via interconnect 44, firewall device 30 and pathway 36. Moreover, in the illustrated embodiment the sole digital communications path between the computer 32 and firewall 30 is via interconnect 44, there not being, by way of example, other wiring or functionality in or associated with device 30 support such communications.

The firewall 30 may be of conventional architecture known in the art, e.g., comprising CPU 46, static storage (e.g., disk 48) and an input/output section 50 (e.g., including a network interface card, modem or other adapter supporting communications via interconnect 44 and link 36). Alternatively, or in addition, the firewall may, by way of example, be implemented in specialized packet-processing or other circuitry.

Regardless, in the illustrated embodiment, CPU 46 is separate and distinct from CPU 38. Thus, by way of example, the firewall device 30 does not use the computer's 32 central processing unit (CPU) 38 to execute firewall logic. More generally, one or more (and, preferably, all) of CPU 46, disk 48 and I/O section 50 of firewall 30 are separate and distinct from CPU 38, disk 40 and I/O section 42 of the computer 32. Put another way, devices 30 and 32 preferably do not share each other's respective CPU, storage or I/O. Likewise, the firewall and computer can each have their own respective power supply (not shown).

The firewall device 30 and computer 32 of the illustrated embodiment each include a security module, labeled 52 and 54, respectively, in the drawing. Module 52 is coupled to the CPU 46, disk 48, I/O section 50 and/or other functionality of firewall device 30 to limit (or prevent) operation, modification and/or connectivity of that device 30, e.g., in the absence of physical, electrical, electromagnetic, magnetic, or other coupling of a token (as described below) and/or external authorization, e.g., from sites 14 and/or 16 or otherwise.

Thus, by way of non-limiting example, absent such coupling and/or authorization, device 30 can be prevented from accessing or permitting access to (or from) selected sites, on at least selected ports, of at least selected packet types, by at least selected applications. Since, in the illustrated embodiment, the device 30 falls on the communications pathway between the computer 32 and the Internet (or other external network) 26, the absence of the aforementioned coupling and/or authorization by device 30, has the effect of likewise preventing computer 32 from accessing (or being accessed from) at least selected sites, on at least selected ports, of at least selected packet types, by at least selected applications.

By way of further non-limiting example, absent the aforementioned coupling and/or authorization, device 30 can be prevented loading at least selected software files, configuration files, patch files, rules files, data and/or other files, (ii) executing at least selected such files, (iii) accessing at least selected peripherals (not shown), and/or (iv) processing at least selected data. This is particularly germane, by way of example, in the illustrated embodiment, wherein firewall 30 is itself implemented using a computer-like architecture, e.g., a CPU, disk and I/O section.

Module 54 is similarly coupled to the CPU 38, disk 40, I/O section 42 and other functionality of computer 32 to limit (or prevent) its operation, modification and/or connectivity in absence of such a token and/or external authorization. Thus, by way of non-limiting example, absent such coupling and/or authorization, computer 32 can be prevented loading at least selected software files, patch files, configuration files, data and/or other files, (ii) executing at least selected software files, configuration files, data files, rules files, patch and/or other files, (iii) accessing to at least selected peripherals (not shown), and/or (iv) processing at least selected data.

Though two separate modules 52, 54 are shown in the drawing, some embodiments use a single module, e.g., serving both firewall 30 and computer 32 or serving only a single one of them, while other embodiments employ still more modules, each serving subsets of CPU, disk, I/O and/or other device functionality of the devices 30, 32. Regardless, such modules can be implemented as hardware and/or software locks, or otherwise, inhibiting operation of the CPU, disk, I/O and/or other functionality to which they are coupled, e.g., in absence of the token and/or external authorization, as discussed further below. With respect to the firewall device 30, module 52 (or its equivalent) can be implemented, by way of non-limiting example, via packet inspection rules that, until released, block all but selected packets types directed to selected addresses by selected application and so forth (e.g., HTTP packets directed to an external authorization site).

The device 10 also includes a reader 56, e.g., on the serial bus 58, that is externally accessible by the operator for entry, keying or other “coupling” of a token. The token can be, by way of example, a smart card, credit card, USB fob, flash card, SD card, memory stick, key, or any other article that signifies its holder as an authorized operator of the device 10 and/or one or more software files patch files, configuration files, rules files, data files and/or other files or components thereof. Preferably, the token uniquely identifies the holder as such, e.g., as is the case with a security key fob token, a credit card, a smart card, a memory card or stick with pre-recorded security code, and so forth; however, this is not a requirement of the invention. Token 60 can be passive or active, e.g., as in the case of a biometric token that scan fingerprints, retinas, and so forth.

The token is preferably of small form factor (e.g., smaller than a 3½″ floppy diskette and, preferably, as small or smaller than a conventional USB “key fob” memory device); however, this is not a requirement of the invention. Hence, a CD, DVD or similar article is used in some embodiments as the token. Preferred tokens are magnetic, electromagnetic, optical, or so forth; however, in some embodiments, metallic “toothed” keys (or their plastic equivalents) are used. Similarly, in some embodiments, the token is a cardboard, paper, plastic, metallic or other card or sheet with a unique security code imprinted on it.

The reader is appropriate to the form factor and type of the expected token 60. Hence, in the case of a smart card, credit card, USB fob, flash card, SD card, memory stick, or the like, the reader comprises a magnetic reader; in the case of a CD, DVD, or the like, it comprises an optical reader; in the case of a toothed key, it comprises an appropriate tumbler or other lock mechanism; in the case of a token with an imprinted security code, it comprises an an optical reader or keypad by which the operator can enter the code; and, so forth. Though illustrated as a separate component of the device 10, it will be appreciated that the reader may be integral with other components of the device (e.g., as in the case, by way of non-limiting example, where a keyboard otherwise provided with the device 10 is also used as a keypad for entry of a code on the token, and/or where a DVD reader otherwise provided for loading of software files, configuration files, data files, rules files, patch files, or otherwise, on the device 10 is also used for reading a DVD token).

Though reader 56 is shown in the drawing coupled to security modules 52, 54 by way of bus 58, it will be appreciated that other mechanisms of coupling the reader to the modules may be utilized, instead or in addition. Moreover, it will be appreciated that though only a single reader 56 is shown in the illustrated embodiment, other embodiments may utilize more readers, e.g., one for each security module. Still further, other embodiments may provide a reader (or readers) for only a single one of the modules 52, 54 and, for example, no reader for the other such module. The utilization of these and other configurations will be evident in the discussion below and elsewhere herein of the operation of device 10.

In addition to reader 56, the firewall device 30 and computer 32 may have one or or other ports, interfaces and peripherals (collectively, “ports”) of the type conventionally used in the art. These can include USB ports, firewire ports, serial ports, ethernet ports, wireless network interface cards (802.11, BlueTooth, etc.), memory cards readers, diskette drives, CD drives, DVD drives, and so forth. Ports 57 of device 30 are coupled the CPU 46, disk 48 and/or I/O section 50 of that device in the conventional manner. Likewise, ports 59 of device 59 are coupled the CPU 38, disk 40 and/or I/O section 42 of that device in the conventional manner. As above, in preferred embodiments, devices 30 and 32 do not share common ports, e.g., other than the reader 56, if even that.

In some embodiments, a “virtual” token 60 is used in place of a physical one as described above. In these embodiments, security codes and/or data structures otherwise maintained on such a physical token are, instead, maintained (at least in part) internal to device 10 (e.g., in a hidden memory location on drives 40 and/or 48, a separate store, and so forth).

A further understanding of the operation of the device 10 of FIG. 3 may be attained by reference to incorporated-by-reference U.S. patent application Ser. No. 11/481,089, entitled “Methods and Apparatus for Digital Data Processor Instantiation,” filed Jul. 5, 2006, a copy of which is attached as an appendix hereto, and, more particularly, for example, by reference to FIGS. 2 and 4-5 and the accompanying text thereof (including, particularly, by way of non-limiting example, the section captioned “Operation”).

FIG. 4 of the instant application depicts a hierarchical system 12 for digital appliance life-cycle management comprising a first set of digital data processing devices 10, a second set of digital data processing devices 16, and a third set of digital data processing devices 14 that are coupled for communications with one another via network(s) 26, as shown. Particularly, the devices 10 of the first set are coupled for communication with the devices 14 of the third set via network(s) 26, and the devices 14 of the third set are, in turn, coupled with the devices 16 of the second set via network(s) 26.

The plurality of digital data processing devices 10 shown in FIG. 4 are constructed and operated as described above. They may be configured as digital data processing appliances (e.g., routers, network security devices, communications devices) of the type commonly used in a modern-day business enterprise, as adapted in accord with the teachings hereof.

Though not a requirement of the invention, one or more of the illustrated devices 10 of FIG. 4 are “headless”—that is, they lack a keyboard, mouse, monitor and/or other peripherals from which an operator would normally monitor, configure and control the device. Likewise, though not a requirement of the invention, one or more of the devices 10 may lack a diskette or CD drive with which to load operating system, application or other software.

Although multiple devices 10 are shown in the drawing, in some embodiments only a single such device is provided.

For sake of convenience, devices 10 are described herein as comprising a so-called first set of digital data processing devices; device(s) 16 are described as comprising a so-called second set of digital data processing devices; and, devices 14 are described as comprising a so-called third set of digital data processing devices.

One, some or all of digital data processors 14, 16, provide for management of the digital data processing devices 10 consistent with the teachings hereof. In the illustrated embodiment, that management function is largely provided by the devices 16 of the second set, though, that function is shared in at least small part with the devices 14 of the third set. In other embodiments, management may be provided solely by the devices of one set (e.g., the second or third set) and/or, conversely, shared more equally among devices of second, third and other sets (including the same or other devices of the first set). Indeed, as noted above, one or more digital data processing devices 10 may be pre-programmed or otherwise to provide for its own management.

The illustrated devices 14, 16 comprise digital data processing “servers” of the type commonly used in modern-day business enterprises, as adapted in accord with the teachings hereof. In other embodiments, the devices 10 may comprise any assortment (heterogeneous, homogeneous, or otherwise) of embedded processors, personal digital assistants (PDAs), personal computers, mainframes, or other digital data processing apparatus of the type known in the art capable of executing applications, programs, and/or processes (again, as adapted for operation in accord with the teachings hereof). Although not discussed further herein for sake of simplicity, these device(s) 14, 16 may be constructed similarly to devices 10, albeit operated as discussed below.

Although multiple digital data processors 14, 16 are shown in the drawings, fewer of these devices may be used in some embodiments of the invention. Conversely, still greater numbers of the devices 14, 16 may be used in other embodiments. Moreover, although illustrated devices 10, 14, 16 are arranged in a hierarchy, other arrangements may be utilized in other embodiments.

Network(s) 26 comprise a communications medium, such as the Internet, intranets, extranets, WANs, MANs, public, private, wireless, wired or otherwise of the type commonly known in the art capable of supporting communications between digital data processors 10, 14, 16 in the manner described herein. The network(s) 26 supporting such communications coupling may be independent and separate from one another, as metaphorically shown in the drawing—though, more often, a common network (e.g., the Internet) or networks (e.g., the Internet and one or more intranets/extranets) provide the requisite coupling.

In the illustrated embodiment, one or more devices 16 in the second set mediate installation, configuration, updating, modification and/or use of assets (e.g., applications, hardware and/or configuration files) on one or more devices 10 of the first set. They achieve this by (a) monitoring the operation of the devices 10 (e.g., via management software 65 and/or devices 14 of the first set), and (b) responding to one or more conditions thereof by selectively installing, configuring, updating and/or limiting unauthorized modification of those assets on devices 10. Although not discussed further herein for sake of simplicity, it will be appreciated that device(s) 16 may similarly mediate the installation, configuration, updating, modification and/or use of assets (e.g., applications, hardware and/or configuration files) by one or more devices 14 of the third set.

Conversely, in the illustrated embodiment, the devices 14 of the third set (which are disposed in communications coupling between and to those of the first and second sets) mediate the transfer of information therebetween. In other embodiments, the devices of the third set may, too, mediate installation, configuration, updating, modification and/or use of assets (e.g., applications, hardware and/or configuration files) on one or more devices 10 of the first set. However, for simplicity, this facet of operation is not discussed further herein.

By way of non-limiting example, in the illustrated embodiment, server 16 can comprise a life-cycle management server 16 (e.g., in the “second set”) operated by an appliance life-cycle maintenance bureau that cooperates with home office servers 14 (“second set”) operated by a customer to manage digital data processing equipment 10 (“first set) at the customer's local offices. The home office servers 14 monitor operation of local equipment 10, directly attending to customer-specific operational issues, such as customer-specific application and/or data transfer errors. The servers 14 pass other issues to the maintenance bureau's server 16, e.g., those pertaining to hardware or OS (or other managed software) errors, so that it can mediate installation replacement hardware or software.

Referring to FIG. 4, one or more devices 16 of the second and/or third sets 16, 14 can monitor at least selected digital data processing devices 10 of the first set to identify conditions therein, based on error messages and other notifications generated by daemons 67, or otherwise. In some embodiments, the devices 14 of the third set act on selected such messages and/or notifications by authorizing the management software 65 on a device 10 which produced the messages/notification to install, configure, update, modify and/or permit use of implicated assets (e.g., assets that caused or are associated with the error messages or other notifications).

In the illustrated embodiment, however, such authorization comes from devices 16 in the second set. To this end, the devices 14 in the third set can include databases 14a for storing error messages and/or other notifications generated by the daemons 67. The devices 16 of the second set can access those databases and/or designated records/fields therein (e.g., periodically, on receipt of messages and/or notifications from devices 10, 14, or otherwise) in order to (i) identify conditions in a device 10 meriting authorization, and (ii) to signal the management software 65 on that device 10 accordingly. Either way, in such arrangements, it can be seen that the management software 65 of that device 10 serves as an agent for the devices 14 and/16 that mediate installation, configuration, updating, modification and/or use of assets on the device 10.

Returning to the example above, and with reference to FIG. 4, the “customer” who operates the home office servers 14 (“third set”) and managed digital data processing equipment 10 (“first set) is responsible for overseeing the basic operation of devices in those sets. This includes everything from deploying the devices, to assigning user names, to insuring proper collection and analysis of data by end users and applications software, etc. It also includes attending to at least certain primary software application 60-64 faults. This is facilitated by a “virtual backplane”, i.e., an HTTPS (or XML)-based display (e.g., generated on a workstation, portable computer or otherwise) associated with those devices, with information generated, for example, by the aforementioned databases (in device(s) 14) or directly from the devices 10, 14 themselves. A system administrator or other person at the customer site can view the virtual backplane to make sure that all is copacetic. Whereas responsibility for overseeing the basic operation of devices 10, 14 in the first and third sets is left to the customer, in this example, responsibility for managing the software images 56, upgrading the software applications 58-65, on the other hand, lies with devices 16.

With further reference to FIGS. 1-4 hereof, managed digital data processing devices 10 of the type described above can be manufactured with pre-installed software applications 59-64 and corresponding configuration files. Following installation at a customer site, management software on the devices can monitor changes to the applications and/or configuration files made (or attempted) by the system administrator, field technician or other to insure that they are permissible—e.g., that they fall within modification bounds pre-programmed into the management software, permitted by external devices or authorization, or otherwise. If not, it blocks them, until authorization is received from an external source, e.g., a life-cycle management server 16 operated by an life-cycle maintenance bureau.

In some embodiments, such authorization (which might be procured by the user, for example, by the payment of necessary fees, attention to necessary paperwork, and so forth) may take the form of a “go ahead” command from the life-cycle management server 16 to the management software 65 on the implicated device 10.

Authorization may take the form, for example, of updates to one or more software applications and/or configuration files on the device 10. These updates may be transmitted by the life-cycle management server 16 to the managed digital data processing device 10 for installation thereon, e.g., by the management software 65. Alternatively, or in addition, they may be unlocked by the management software 65—e.g., using a key provided by the life-cycle management server 16—from stores (hidden or otherwise) on the managed digital data processing device(s).

To continue the example, the management software 65 on each respective managed device 10 monitors that device's operations, e.g., using an asset management, health management, licensing, randomized instruction set emulation and other daemons, and sends a notification to the life-cycle management server 16 (or an intermediate server 14) upon the detection of error, inconsistency or otherwise. In addition to reporting and logging those notifications, e.g., for review by appliance life-cycle maintenance bureau personnel, the life-cycle management server 16 can download appropriate updates, e.g., to software applications and/or configuration files, e.g., in order to eliminate or minimize further error, inconsistency or otherwise.

By way of still further continuance of the example, managed digital data processing devices 10 can be shipped to, or otherwise provided at, a remote or other site with (i) the firewall device 30 “locked down” so as to provide restricted connectivity, if any, to the Internet (or other external network), and (ii) a limited set of pre-installed software files 58-65, configuration files, if any. An authorization token, e.g., of the type mentioned above, can be inserted into the managed device (e.g., once located at the remote or other site) and, as a result thereof, connectivity is established, e.g., over the Internet (or other external network), with the life-cycle management server 16 (or other external source, e.g., a device 14). That server 16 (or other external source) authenticates the managed device 10, signaling a security module to remove or loosen restrictions on operating and/or updating the device (including, for example, restrictions on booting the computer 32, loading or executing software files, configuration files, etc., accessing peripherals, and/or processing data). Such signaling by the server (or other external source) can also result in installation and/or modification of software applications and/or configuration files by the respective management software 65.

Discussed above and shown in the drawings are systems, devices and methods meeting the desire objects, among others. It will be appreciated, of course, that the embodiments shown herein are merely examples of the invention and that other embodiments varying from those shown herein fall within the scope of the invention.

In view thereof, what I claim is:

1. A managed digital data processing device comprising
A. a processing section and a store coupled thereto,
B. one or more assets, including any of (i) software applications contained in the store and and/or capable of executing on the processing section, (ii) hardware devices in communications coupling with the processing section, and/or configuration files for such software applications and/or hardware devices, and
C. management software executing on the processing section that manages installation, configuration, updating, and/or other modifications of the assets, the management software validating a requested change to an asset and propagating one or more related changes to other assets.

2. The managed digital data processing device of claim 1, wherein the management software validates a change to an asset received from a system administrator, field technician, external device or otherwise.

3. The managed digital data processing device of claim 1, wherein the management software monitors at least selected changes to insure that they are permissible and, if not blocks them.

4. The managed digital data processing device of claim 1, wherein the management software validates a state of the digital data processing device any of before or in connection with making a requested change.

5. The managed digital data processing device of claim 4, wherein the management software validates the state of the digital data processing device by inventorying its assets and comparing them with an expected inventory.

6. The managed digital data processing device of claim 4, wherein the management software validates the state of the digital data processing device by inventorying its assets to determine whether the software and/or hardware therein are compatible and/or can be expected to work well together.

7. The managed digital data processing device of claim 1, wherein the management software makes a back-up of at least selected digital data processor assets prior to effecting the requested change.

8. The managed digital data processing device of claim 4, wherein the management software quashes a requested change if validation fails.

9. The managed digital data processing device of claim 1, wherein the management software unlocks the digital data processing device to permit a requested change to proceed.

10. The managed digital data processing device of claim 9, wherein the management software unlocks the digital data processing device by making available for access hidden, protected and/or encrypted files, operating system functions and/or registry entries.

11. The managed digital data processing device of claim 10, wherein the management software locks the digital data processing device after making or attempting a requested change, wherein such locking includes any of hiding, protecting and/or encrypting files, operating system function and/or registry entries.

12. The managed digital data processing device of claim 10, wherein the management software, in addition to making a requested change to an asset of the digital data processing device, propagates related changes to other assets of the device.

13. A life-cycle managed digital data processing device comprising
A. a processing section,
B. an operating system executing on the processing section,
C. one or more assets, including any of (i) software applications executing on the operating system, (ii) hardware devices operating in connection with the operating system, and/or configuration files for such applications and/or hardware devices,
E. management software that serves as an agent for one or more external digital data processing devices that are in communications coupling with the managed digital data processing device, which one or more external digital data processing devices mediate installation, configuration, updating, modification and/or use of the one or more assets on the managed digital data processing device.

14. The life-cycle managed digital data processing device of claim 13, wherein the management software restricts at least one of installation, configuration, updating and/or use of at least selected assets on the managed digital data processing device absent authorization by the one or more external devices.

15. The life-cycle managed digital data processing device of claim 13, wherein the management software executes on the operating system.

16. The life-cycle managed digital data processing device of claim 13, wherein the management software has exclusive right to install, configure, update and/or use of at least selected assets on the managed digital data processing device of the first set of devices.

17. The life-cycle managed digital data processing device of claim 13, wherein the management software limits and/or confirms installation, configuration, updating and/or use of at least selected assets on the managed digital data processing device.

18. The life-cycle managed digital data processing device of claim 13, wherein the management software detects a selected condition in any of state, configuration and operation of a respective aspect of the managed digital data processing device.

19. The life-cycle managed digital data processing device of claim 13, wherein the management software generates an error message and/or other notification in response to detection of a selected condition in any of state, configuration and operation of a respective aspect of the managed digital data processing device.

20. The life-cycle managed digital data processing device of claim 13, wherein the management software comprises one or more daemons, each executing on the operating system, modeling a respective aspect of the managed digital data processing device.

21. The life-cycle managed digital data processing device of claim 20, wherein one or more of the daemons detect a selected condition in any of state, configuration and operation of a respective aspect of the managed digital data processing device.

22-30. (canceled)

31. A digital data processing system comprising
A. a first set of one or more digital data processing devices,
B. a second set of one or more digital data processing devices that are coupled to the first set, wherein one or more devices in the second set mediate installation, configuration, updating, modification and/or use of assets on at least a selected digital data processing device in the first set of devices, where those assets include any of (i) software applications, (ii) hardware devices, and/or (iii) configuration files for those applications and/or hardware devices.

32. The digital data processing system of claim 31, wherein the one or more devices of the second set (a) monitor the operation of one or more devices in the first set, and (b) respond to one or more selected conditions in at least a selected digital data processing device by selectively installing, configuring, updating and/or limiting unauthorized modification of assets on the selected digital data processing device of the first set of devices.

33. The digital data processing system of claim 31, wherein at least the selected digital data processing device of the first set of devices comprises management software that serves as an agent for the one or more devices in the second set that mediate installation, configuration, updating, modification and/or use of assets on that selected digital data processing device.

34. The digital data processing system of claim 33, wherein the management software restricts installation, configuration, updating and/or use of at least selected assets on the selected digital data processing device of the first set of devices absent authorization by one or more devices in the second set.

35-50. (canceled)

51. A digital data processing system comprising
A. a first set of one or more digital data processing devices,
B. a second set of one or more digital data processing devices that are coupled to the first set, wherein one or more devices in the second set mediate installation, configuration, updating, modification and/or use of assets on at least a selected digital data processing device in the first set of devices,
C. a third set of digital data processing devices that are coupled in between and to the first and second sets of devices in order to mediate a transfer of information at least from the selected digital data processing device of the first set of devices to one or more devices of the second set,
D. where the assets include any of (i) software applications, (ii) hardware devices, and/or (iii) configuration files for those applications and/or hardware devices.

52-76. (canceled)

77. A method of managing a digital data processing device comprising
A. providing a digital data processing device (“managed digital data processing device”) with
i. a processing section,
ii. an operating system executing on the processing section,
iii. one or more assets, including any of software applications executing on the operating system, hardware devices operating in connection with the operating system, and/or configuration files for such applications and/or hardware devices,
B. executing management software on the managed device that serves as an agent for one or more external digital data processing devices that are in communications coupling with the managed digital data processing device, which one or more external digital data processing devices mediate installation, configuration, updating, modification and/or use of the one or more assets on the managed digital data processing device.

78-85. (canceled)

86. A method of managing a digital data processing devices comprising
A. providing a first set of one or more digital data processing devices,
B. providing a second set of one or more digital data processing devices that are coupled to the first set of digital data processing devices,
C. with one or more devices in the second set, mediating installation, configuration, updating, modification and/or use of assets on at least a selected digital data processing device in the first set, where those assets include any of (i) software applications, (ii) hardware devices, and/or (iii) configuration files for those applications and/or hardware devices.

87. The method of claim 86, comprising the step
A. with one or more devices of the second set, monitoring the operation of one or more devices in the first set, and
B. with one or more devices of the second set, responding to one or more selected conditions in at least a selected digital data processing device by selectively installing, configuring, updating and/or limiting unauthorized modification of assets on the selected digital data processing device of the first set of devices.

88. The method of claim 86, comprising the step of executing management software on the selected digital data processing device that serves as an agent for the one or more devices in the second set that mediate installation, configuration, updating, modification and/or use of assets on that selected digital data processing device.

89-96. (canceled)

97. A method of managing a digital data processing devices comprising
A. providing a first set of one or more digital data processing devices,
B. providing a second set of one or more digital data processing devices that are coupled to the first set of digital data processing devices,
C. providing a third set of digital data processing devices that are coupled in between and to the first and second sets of devices,
D. with one or more devices in the second set, mediating installation, configuration, updating, modification and/or use of assets on at least a selected digital data processing device in the first set, where those assets include any of (i) software applications, (ii) hardware devices, and/or (iii) configuration files for those applications and/or hardware devices, and
E. with one or more devices in the third set, mediating a transfer of information at least from the selected digital data processing device of the first set of devices to one or more devices of the second set.

98-108. (canceled)

109. A method of managing a digital data processing device comprising
A. executing on the digital data processing device software that manages installation, configuration, updating, and/or other modifications of assets of the device, where those assets include any of (i) software applications contained in the store and/or capable of executing on the processing section, (ii) hardware devices in communications coupling with the processing section, and/or configuration files for such software applications and/or hardware devices,
B. with the management software, validating a requested change to an asset and propagating one or more related changes to other assets.

110. The method of claim 109, comprising, with the management software, validating a change to an asset received from a system administrator, field technician, external device or otherwise.

111. The method of claim 109, comprising, with the management software, monitoring at least selected changes changes to insure that they are permissible and, if not blocks them.

112. The method of claim 109, comprising, with the management software, validating a state of the digital data processing device any of before or in connection with making a requested change.

113. The method of claim 112, comprising, with the management software, validating the state of the digital data processing device by inventorying its assets and comparing them with an expected inventory.

114. The method of claim 112, comprising, with the management software, validating the state of the digital data processing device by inventorying its assets to determine whether the software and/or hardware therein are compatible and/or can be expected to work well together.

115. The method of claim 109, comprising, with the management software, making a back-up of at least selected digital data processor assets prior to effecting the requested change.

116. The method of claim 112, comprising, with the management software, quashing a requested change if validation fails.

117. The method of claim 109, comprising, with the management software, unlocking the digital data processing device to permit a requested change to proceed.

118. The method of claim 117, comprising, with the management software, unlocking the digital data processing device by making available for access hidden, protected and/or encrypted files, operating system functions and/or registry entries.

119. The method of claim 118, comprising, with the management software, locking the digital data processing device after making or attempting a requested change, wherein such locking includes any of hiding, protecting and/or encrypting files, operating system function and/or registry entries.

120. The method of claim 118, comprising, with the management software, in addition to making a requested change to an asset of the digital data processing device, propagates related changes to other assets of the device.
